(19) United States
(12) Patent Application Publication
(10) Pub. No.: US 2010/0107016 A1
(43) Pub. Date: Apr. 29, 2010

(54) SYSTEM AND METHOD FOR PREVENTING ERRORS INA STORAGE MEDIUM

(76) Inventors: Gerald Adolph Colman, Fishers, IN (US); John Spencer Dyson, Indianapolis, IN (US); William Charles Koester, Grosse Ile, MI (US); Raul Galindez-Torres, Fort Wayne, IN (US); Ronald G. Wolenty, Fishers, IN (US)

Correspondence Address: Robert D. Shedd, Patent Operations;THOMSON Licensing LLC, P.O. Box 5312, Princeton, NJ, 08543-5312, US

(21) Appl. No.: 12/450,393

(22) PCT Filed: Dec. 7, 2007
(86) PCT No.: PCT/US07/25169

§ 371 Date: Sep. 23, 2009

Related U.S. Application Data
(60) Provisional application No. 60/919,751, filed on Mar. 23, 2007.

(51) Int. Cl. G06F 11/07; G06F 12/08

(52) U.S. Cl. 714/48; 711/141; 711/E12.017; 714/E11.025

(57) ABSTRACT

The system and method for preventing write errors in storage mediums includes detecting the presence of an early power fail (EPF) signal derived from a power supply circuit providing power to the storage device. In response to the EPF signal, a modified standby-immediate (MSI) command is issued to the Storage device controller circuitry. The storage device controller circuitry responds by causing the storage medium to finish the current write operation and cease all future write operations. In this manner, write errors are prevented by causing the storage device to cease write operations before the expiration of predetermined time period between the issuance of the EPF signal and actual power failure.

### CROSS-REFERENCE TO RELATED APPLICATIONS

This application claims the benefit of U.S. Provisional Application Ser. No. 60/919,751, filed 23 Mar. 2007, which is incorporated by reference herein in its entirety.

### BACKGROUND

1. Technical Field

The present principles relates to storage devices. More particularly, it relates to the handling of storage devices in the presence of power failure events.

2. Description of the Prior Art

Video recording devices are more prevalent today than ever before, replacing, in many cases, older video cassette recorder devices. The new video recording devices often employ digital technologies including a Hard-Disk Drive (HDD). Power interruption due to a power failure event in these new video recording devices may result not only in loss of video content during the outage, but also the corruption of video information stored on the drive immediately before and/or immediately after the power outage. In some systems such as computer applications, critical operating-system data may be mirrored on two sectors or segments of the HDD. As a result, when the system boots and reads bad data it will seek to the mirrored sector and get the correct data in order to continue the boot-process. A routine to copy the data into the bad-sector from the good sector; thus, repairing that sector. However, such a duplication of data writing and storage may not be a practical option for video data storage use of the drive, may not be cost effective, or may be difficult due to implementation of the file and data management system.

Generally speaking, a Write-Splice error occurs on a HDD when data is being written from a memory cache to the storage medium or platter and power is suddenly removed. The write splice error results in corrupt data residing on the sector at the moment the drive was writing to when power was removed. The sector will contain some data from before the event and the rest of the data from after. The cyclical redundancy check (CRC) for that sector will not be correct since it will be based on only data before the event. Therefore, when power is restored and the sector read, the CRC on that sector will not match the CRC generated by the Host when reading the contents of that sector. If the written data is critical, such as operating-system data for a device, and the write-splice occurs, the device may fail to finish its boot process when power is reapplied. Further, if the data is related to a data stream such as video, the error may create issues with maintaining operation such as display of the video.

### SUMMARY

According to one exemplary aspect of the present invention, the method comprises detecting a signal such as, for example, an early power fail (EPF) signal from power supply circuitry providing power to a storage device, issuing a command such as, for example, a modified standby immediate (MSI) command to controller circuitry of the storage device in response to a detected signal, and in response to the issued command, completing a current data write operation to a particular sector being written and ceasing further write operations to the storage medium.

The issuing command can further include sending an acknowledgement signal to a controller indicating that the MSI command has been issued and write operations for the storage device are being managed in accordance with the MSI command.

The remaining cached data for writing to the storage medium is discarded. This discarding may be performed by the loss of power to the cache memory at the end of the EPF signal.

According to another aspect the apparatus of the present principles includes a controller configured to receive and provide data to an end user, a power supply circuit configured to provide power to the controller, said power supply circuit providing an early power fail (EPF) signal to the controller in the event of a power failure, a storage device having circuitry in communication with said controller and configured to enable selective storage of the data information according to a user preference, and a mechanism by which a modified standby immediate (MSI) command is provided to the controller circuitry of the storage device in response to a detected EPF signal from the power supply circuit. The MSI command causes the circuitry of the storage device to complete a current data write operation to a particular sector of the storage medium and cease all further write operations.

The details of one or more implementations are set forth in the accompanying drawings and the description below. Even if described in one particular manner, it should be clear that implementations may be configured or embodied in various manners. For example, an implementation may be performed as a method, or embodied as an apparatus configured to perform a set of operations or an apparatus storing instructions for performing a set of operations. Other aspects and features will become apparent from the following detailed description considered in conjunction with the accompanying drawings and the claims.

### BRIEF DESCRIPTION OF THE DRAWINGS

In the drawings wherein like reference numerals denote similar components throughout the views:

FIG. 1 is a block diagram illustrating a set top box with the method of the present principles implemented therein;

FIG. 2 is a timing diagram of the events and signals according to an implementation of the present principles;

FIG. 3a is a flow diagram of the method according to an implementation of the present principles;

FIG. 3b is a flow diagram of the method according to another implementation of the present principles.

### DETAILED DESCRIPTION

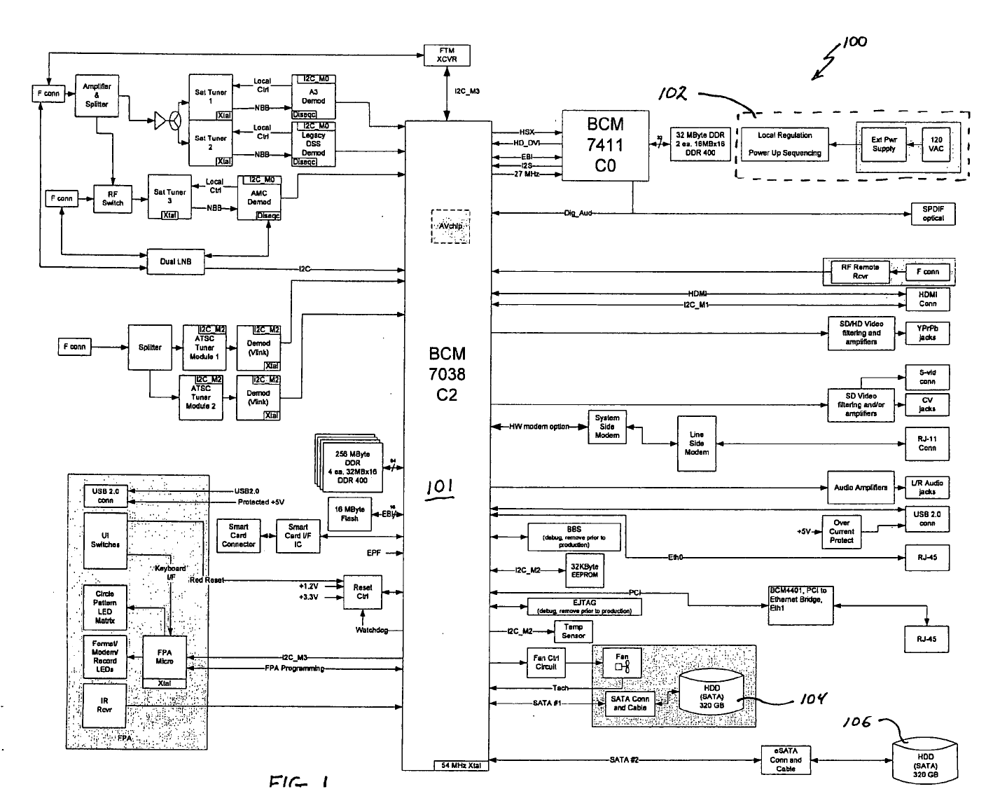

FIG. 1 illustrates a schematic block diagram of a set top box 100 used for receiving and recording data such as audio and video delivered over a satellite network. The set top box contains circuitry for receiving and demodulating satellite signals in a format such as quaternary phase shift keying (QPSK) containing error correction. The demodulated signal, a transport stream, is further decoded using Moving Picture Experts Group (MPEG) processing, into individual streams of video and audio. The video and audio signals may be sent to a display device, not shown. A controller 101 manages the operation of the set top box including the user interface and routing of the signals to the various blocks and connectors. The controller 101 also controls signals routed to and from a storage device (104, 106) such as a HDD.

One implementation of the present principles employs an Early-Power-Fail (EPF) signal derived from the power supply circuitry 102 that notifies the controller 101 approximately 30 ms before power is ultimately interrupted to circuits such as the HDD.

Under normal circumstances, a normal Standby Immediate command that is issued will flush the cached data to the platter of the HDD, then park the heads. Since normal cache size is 8 MB, it is very common that the cache flush can take longer than the EPF time (i.e., 30 ms) available. By issuing the standard (unmodified) standby immediate command in response to the EPF actually makes matters worse, This is because by issuing the standard (unmodified) command, it is essentially assured that the HDD will be writing to the platter when the 30 ms expires and power is actually lost. As mentioned above, this is a scenario that will cause write splice errors.

According to one implementation, once the controller recognizes the EPF interrupt signal, a routine is entered to send a modified Standby-Immediate (MSI) command to the HDD circuit. The modified Standby-Immediate (MSI) command is configured to modify the behavior of the HDD command so that just the sector that is currently being written (i.e., when the EPF is detected) is finished, and the rest of the cache memory is discarded rather than written and then parking the heads. The HDD recognizes the modified Standby-Immediate command and finishes the current data write of data to the sector on the HDD storage medium. The HDD then ceases its write operation and will not do any more write operations to the HDD storage medium. The combination of the EPF signal and the modified Standby-Immediate command guarantees that all write functions to the HDD storage medium have been successfully completed before power is interrupted by allowing the drive to complete the last sector write and park the heads. This will prevent a write splice error situation from occurring.

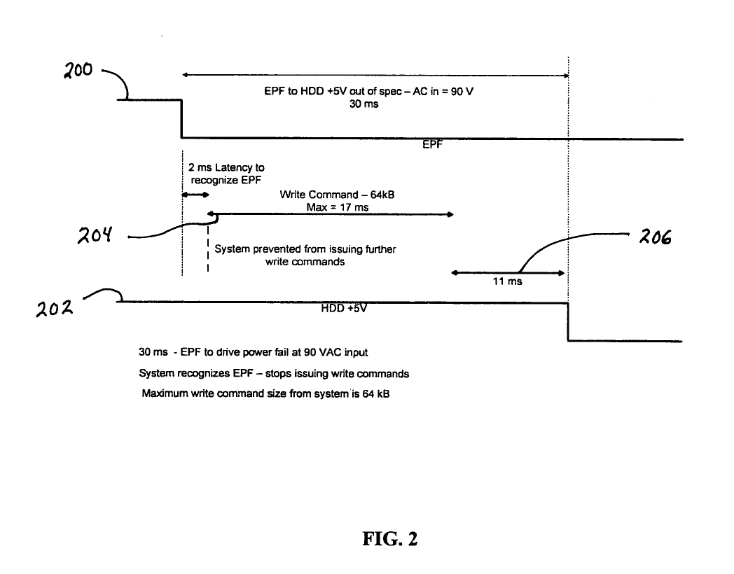

FIG. 2 shows a representative timing diagram showing the timing of events related to operation of the HDD using aspects of the present embodiment. The EPF signal 200 is shown as occurring approximately 30 ms before the 5V power signal 202 to the HDD actually drops out of regulation due to a power fail event. The modified Standby-Immediate (MSI) command 204 for the HDD is shown starting after recognizing the EPF signal and before the 5V power signal to the HDD drops out of regulation due to the power failure. Generally, it takes no more than 2 ms to detect the EPF signal once generated by the power supply circuit 101. Once detected, the MSI command is issued, preferably immediately, and the final write command should not take more than 17 ms in duration. This 17 ms duration is enough time to provide for a maximum write command size from the system of 64 kB. According to this implementation, this provides an additional 11 ms buffer of time 206 (i.e., during the normal 30 ms shutdown time period), if needed, for the HDD to finish its write operation to the particular sector, park the heads and dump the remaining cached memory data. Thus, after detecting the presence of the EPF signal, the system of the present principles will complete the current data write operation, park the heads and shut down the storage device in no more than the remaining 28 ms before power failure (i.e., 30 ms-2 ms to detect EPF in the present example).

FIG. 2 shows an example where the EPF time is ˜30 ms. This EPF time is presented here as an example only, and those of skill in the art will recognize that EPF times for storage devices may vary between manufacturers. The MSI of the present principles will operate to increase the time available in the EPF regardless of the manufacturer's specifications relating to the same.

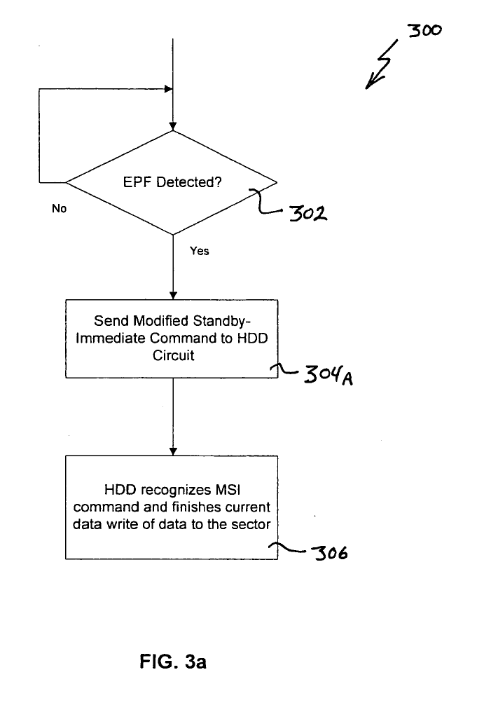

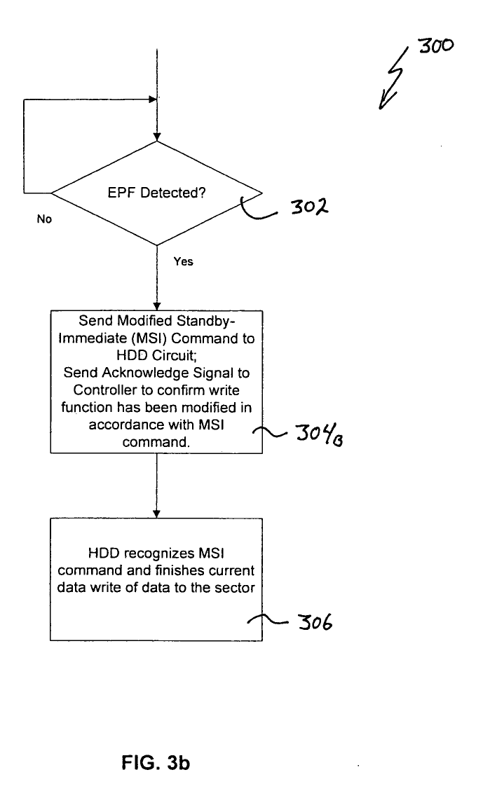

FIG. 3a shows a flow diagram of the method 300 according to the present principles. As mentioned above, initially the presence of the EPF is detected (302). When the EPF is detected, the Modified Standby Immediate (MSI) command is sent to the HDD circuit (304a). In response, the HDD recognizes the MSI signal and finishes its current data write cycle of data to that particular sector and discards any remaining cached data without writing that data to the storage medium (306). The remaining data in the cache will be discarded when the power is eventually lost and the RAM cache in the HDD loses its data.

According to another implementation shown in FIG. 3b, the modified Standby-Immediate (MSI) command may also provide an acknowledge signal back to the controller to confirm that the modified write function was properly implemented (304b). Use of the modified Standby-Immediate command of the present principles, in conjunction with the EPF signal, operates to prevent a write splice error from occurring in the storage medium, and allow further writing to be suspended as a result of the power fail event.

Features and aspects of described implementations may be applied to various applications. Applications include, for example, individuals using host devices in their homes to communicate with the Internet using an Ethernet-over-cable communication framework, as described above. However, the features and aspects herein described may be adapted for other application areas and, accordingly, other applications are possible and envisioned. For example, users may be located outside of their homes, such as, for example, in public spaces or at their jobs. Additionally, protocols and communication media other than Ethernet and cable may be used. For example, data may be sent and received over (and using protocols associated with) fiber optic cables, universal serial bus (USB) cables, small computer system interface (SCSI) cables, telephone lines, digital subscriber line/loop (DSL) lines, satellite connections, line-of-sight connections, and cellular connections.

The implementations described herein may be implemented in, for example, a method or process, an apparatus, or a software program. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data transmission and reception. Examples of equipment include video coders, video decoders, video codecs, web servers, set-top boxes, laptops, personal computers, and other communication devices. As should be clear, the equipment may be mobile and even installed in a mobile vehicle.

Additionally, the methods may be implemented by instructions being performed by a processor, and such instructions may be stored on a processor-readable medium such as, for example, an integrated circuit, a software carrier or other storage device such as, for example, a hard disk, a compact diskette, a random access memory (“RAM”), or a read-only memory (“ROM”) The instructions may form an application program tangibly embodied on a processor-readable medium. As should be clear, a processor may include a processor-readable medium having, for example, instructions for carrying out a process.

As should be evident to one of skill in the art, implementations may also produce a signal formatted to carry information that may be, for example, stored or transmitted. The information may include, for example, instructions for performing a method, or data produced by one of the described implementations. Such a signal may be formatted, for example, as an electromagnetic wave (for example, using a radio frequency portion of spectrum) or as a baseband signal. The formatting may include, for example, encoding a data stream, packetizing the encoded stream, and modulating a carrier with the packetized stream. The information that the signal carries may be, for example, analog or digital information. The signal may be transmitted over a variety of different wired or wireless links, as is known.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are within the scope of the following claims.

1. A method comprising the steps of:
detecting an power fail signal that indicates a pending power loss in a set top box;
generating a signal responsive to said power fail signal; and
outputting a control signal to halt data storage without corrupting stored data.

2. The method of claim 1 wherein the control signal is a modified standby immediate (MSI) command to controller circuitry of the storage medium.

3. The method of claim 2 wherein the controller circuitry of the storage medium completes a current data write operation and ceases further write operations.

4. The method of claim 2, wherein said generating further comprises sending an acknowledgement signal to a controller indicating that the MSI command has been issued and write operations for the storage medium are being managed in accordance with the MSI command.

5. The method of claim 2, further comprising discarding remaining cached data.

6. The method of claim 5, wherein said discarding is performed by loss of power to cache memory at an end of the early power fail signal.

7. An apparatus comprising:
a controller configured to provide commands to a storage device;
a circuit providing an early power fail (EPF) signal to the controller in the event of a pending power failure in a set top box;
a storage device having controller circuitry in communication with said controller; and
means for providing a command to the storage device said command indicating said storage device is to complete a current data write and cease further write operations.

8. The apparatus of claim 7, wherein said means for providing further comprises: means for discarding cached data remaining after completing the current data write operation.

9. The apparatus of claim 7, further comprising means for providing an acknowledgement signal to the controller indicating that said command has been issued and the write operations for the storage device are being managed according to the command.

10. The apparatus of claim 8, wherein said discarding means comprises loss of power to a cache memory holding the cached data at an end of the EPF signal.

11. A computer program product comprising a computer useable medium having computer readable program code embodied thereon for use in communicating between elements of a set top box, the computer program product comprising:
program code for detecting an early power fail (EPF) signal from circuitry providing power to a storage device;
program code for issuing a command to controller circuitry of the storage device;
program code for causing the controller circuitry of the storage device to complete a current data write operation when the command is issued; and
program code for ceasing further write operations to the storage medium.

12. The computer program product of claim 11, further comprising program code for sending an acknowledgement signal to a controller indicating that said command has been issued and write operations for the storage medium are being managed according to the command.
